(19) United States
(12) Patent Application Publication
(10) Pub. No.: US 2016/0156185 A1
(43) Pub. Date: Jun. 2, 2016

(54) CONTROLLING POWER DISTRIBUTION OF A FIXED CAPACITY POWER GRID

(71) Applicant: Shenyang Neusoft Medical Systems Co., Ltd., Shenyang (CN)

(72) Inventors: Shuangxue Li, Shenyang (CN); Qiang Zhang, Shenyang (CN); Xiaoping Shi, Shenyang (CN)

(21) Appl. No.: 14/953,021

(22) Filed: Nov. 27, 2015

(30) Foreign Application Priority Data
Nov. 27, 2014 (CN) 201410706982.6

(51) Int. Cl. H02J 3/00; G05B 15/02

(52) U.S. Cl. CPC H02J 3/00; G05B 15/02

(57) ABSTRACT

A method and an apparatus for controlling power distribution in a fixed capacity power grid are disclosed. A power request from a piece of user equipment can be received, wherein the power request can indicate an operating mode of the user equipment. A power demand capacity of the user equipment can be determined according to the operating mode. It can be determined whether the current available power capacity is larger than or equal to the power demand capacity of the user equipment. If it is, the power grid can be controlled to supply power to the user equipment; otherwise, a waiting instruction can be sent to the user equipment, and the power request can be placed into a waiting queue; and when the available power capacity of the power grid is larger than or equal to the power demand capacity of the user equipment corresponding to the first power request in the waiting queue, the power grid can be controlled to supply power to the user equipment corresponding to the first power request in the waiting queue.

The present application claims the priority to Chinese Patent Applications No. 201410706982.6, filed with the Chinese State Intellectual Property Office on Nov. 27, 2014, which is incorporated herein by reference in its entirety.

### BACKGROUND

The present disclosure relates to the field of power grid.

A method and apparatus for controlling power distribution of a fixed capacity power grid, which can utilize the fixed capacity of the power grid as full as possible, improve power utilization and reduce the cost of power supply, is desirable.

NEUSOFT MEDICAL SYSTEMS CO., LTD. (NMS), founded in 1998 with its world headquarters in China, is a leading supplier of medical equipment, medical IT solutions, and healthcare services. NMS supplies medical equipment with a wide portfolio, including CT, MRI, digital X-ray machine, Ultrasound, PET (Positron Emission Tomography), Linear Accelerator, and Biochemistry Analyser. Currently, NMS' products are exported to over 60 countries and regions around the globe, serving more than 5,000 renowned customers. NMS's latest successful developments, such as 128 Multi-Slice CT Scanner System, Superconducting MRI, Linear Accelerator, and PET products, have led China to become a global high-end medical equipment producer. As an integrated supplier with extensive experience in large medical equipment, NMS has been committed to the study of avoiding secondary potential harm caused by excessive X-ray irradiation to the subject during the CT scanning process.

### BRIEF DESCRIPTION OF DRAWINGS

Features of the present disclosure are illustrated by way of example and not limited in the following figure(s), in which like numerals indicate like elements, in which:

FIG. 1 is a flowchart illustrating a method for controlling power distribution of a fixed capacity power grid according to an example of the present disclosure;

FIG. 2 is a flowchart illustrating a method for controlling power distribution of a fixed capacity power grid according to another example of the present disclosure;

FIG. 3 is a schematic diagram illustrating a hardware structure of an apparatus for controlling power distribution of a fixed capacity power grid according to an example of the present disclosure;

FIG. 4 is a schematic block diagram illustrating functional modules of a control logic for controlling power distribution of a fixed capacity power grid according to an example of the present disclosure;

FIG. 5 is a schematic block diagram illustrating functional modules of a control logic for controlling power distribution of a fixed capacity power grid according to another example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

An apparatus, such as a computed tomography (CT) apparatus, an X-ray scanning apparatus and a magnetic resonance imaging (MRI) apparatus which may require an extremely high instantaneous power, generally has operating characteristics including long standby time with low power consumption, and short operating time with high power consumption. The apparatus as mentioned above may stand by for a long time in one day, as long as several or tens of hours, during which the power consumption can be relatively low, e.g., only several kilovolt-amperes; in contrast, such apparatus may operate for a short time in one day, e.g., each operating time may last tens of milliseconds, hundreds of milliseconds or tens of minutes, during which the power consumption can be relatively high, e.g., as much as tens or hundreds of kilovolt-amperes.

In general, a power supply facilities of a power grid should be configured according to the maximum instantaneous power of the apparatuses so as to meet their power demands In this way, the cost and installation space of the power supply facilities could both increase, while power utilization of the power grid could be low due to the above-mentioned operating characteristics of such apparatuses.

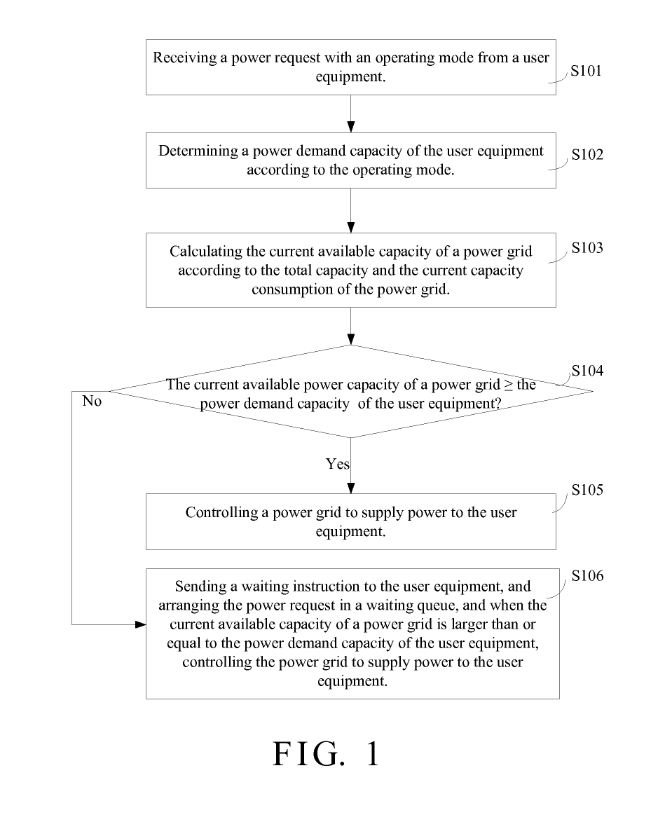

Referring to FIG. 1. FIG. 1 is a flowchart illustrating a method for controlling power distribution of a fixed capacity power grid according to an example of the present disclosure, which may be applied to an apparatus for power distribution control. As shown in FIG. 1, the method may comprise:

At block S101, a power request with an operating mode can be received from a piece of user equipment.

At block S102, a power demand capacity of the user equipment can be determined according to an operating mode of the user equipment. The power demand capacity of the user equipment indicates how much power is demanded by the user equipment. For example, a power distribution control apparatus can communicate with a piece of user equipment via a network, wherein the user equipment may require a high instantaneous power, and the power distribution control apparatus may receive a power request from the user equipment. For instance, a power request can be initiated from the user equipment through pressing a button implemented by a software or a hardware element of the user equipment.

The user equipment may be configured to have multiple operating modes to meet various user demands. In the different operating modes, the user equipment may operate for different time periods and can have different power demand capacities. For example, the user equipment may be pre-configured to have a manual mode and an automatic mode, and usually, the user equipment may operate for a relatively short time period in the manual mode, e.g., about a few seconds to ten minutes, and may operate for a relatively long time period in the automatic mode, e.g., about several quarters to a few hours. Of course, multiple operating modes may be also pre-configured according to different demands of a user; each type of the operating modes can have a different operating time period and a different power demand capacity. In order to facilitate the implementation of the method for controlling power distribution, the power distribution control apparatus can be configured to store different types of pre-configured operating modes and operating time periods and power demand capacities corresponding to the preconfigured operating modes.

At block S103, the current available capacity of a power grid can be calculated according to the total capacity and the current capacity consumption of the power grid.

Particularly, the block may be implemented in the following way, including:

calculating the sum of the power demand capacities of one or more pieces of user equipment that are in an operating state and standby power demand capacities of all user equipment as the current capacity consumption; and

calculating the difference between the total capacity and the current capacity consumption as the current available capacity of the power grid.

It should be understood that, block S103 may be performed before any other blocks, for example, it may performed before block S102 or even block S101, as long as the current available capacity of the power grid is known before the method proceeds to block S104.

At block S104, it can be determined whether the current available power capacity of a power grid is larger than or equal to the power demand capacity of the user equipment; if it is, the method proceeds to block S105; if it isn't, the method proceeds to block S106.

At block S105, a power grid can be controlled to supply power to the user equipment.

At block S106, a waiting instruction can be sent to the user equipment, and the power request can be placed in a waiting queue, and when the current available capacity of a power grid is larger than or equal to the power demand capacity of the user equipment corresponding to the first power request in the waiting queue, the power grid can be controlled to supply power to the user equipment corresponding to the first power request in the waiting queue.

Further, after the current available power capacity of a power grid is calculated, it can be determined whether the power grid is able to supply power to the requesting user equipment to satisfy its power demand. For example, let the current available capacity of a power grid be T1 and let the power demand capacity of a piece of user equipment be T2; when T1>=T2, it indicates that the current available capacity for the power grid is sufficient to supply power to the user equipment, such that, the apparatus for controlling power distribution may control the power grid to supply power to the user equipment; however, when T1<T2, it indicates that the current available power capacity of the power grid is not enough to support the power supply for the user equipment, thus the apparatus for controlling power distribution has to send a waiting instruction to the user equipment, and when receiving the waiting instruction, the user equipment may need to wait until when the power grid is able to supply power to the user equipment to operate, and at that time, the apparatus for controlling power distribution controls the power grid to supply power to the user equipment.

In some examples, block S106 may be implemented in the following way, including:

sending a waiting instruction to the user equipment and placing the power request from the user equipment into a waiting queue according to an ascending order for the reception time when the power request is received; and

according to a first-in-first-out (FIFO) rule for the power requests in the waiting queue, sequentially processing the power requests in the waiting queue, and when the available power capacity of the power grid is larger than or equal to the first power demand capacity of the first power request in the waiting queue, controlling the power grid to supply power to the user equipment corresponding to the first power request in the waiting queue.

In some examples, block S106 may be implemented in the following way, including:

sending a waiting instruction to the user equipment, and placing the power request from the user equipment into the waiting queue according to an ascending order for the power demand capacity of the user equipment; and

according to an ascending order of the power demand capacities of the power requests in the waiting queue, sequentially processing the power requests in the waiting queue, and when the available power capacity of the power grid is larger than or equal to the power demand capacity of the first power request in the waiting queue, controlling the power grid to supply power to the user equipment corresponding to the first power request in the waiting queue.

In this way, the power requests are arranged in the waiting queue in an ascending order according to the power demand capacities of the power requests in the waiting queue, and the apparatus for controlling power distribution may process each of the power requests according to the arranged order in the waiting queue.

However, in some situations, there can be some emergency requests which need to be processed timely. In order to deal with this case, the present disclosure provides a solution wherein the power requests are assigned priorities indicating corresponding degrees of importance. A higher priority represents a more important task which is more urgently demanding a timely processing.

For the requests with priorities, Block S106 may be implemented in following way, including:

sending a waiting instruction to the user equipment and placing the power request from the user equipment in the waiting queue according to a descending order for the priority associated with the power request and/or an ascending order for the reception time of the power request; and

sequentially processing the power requests in the waiting queue, and when the current available capacity of the power grid is larger than or equal to the power demand capacity of the first power request in the waiting queue, controlling the power grid to supply power to the user equipment corresponding to the first power request for power consumption.

In this way, the apparatus for controlling power distribution sequentially processes each of the power requests according to the arranged order in the waiting queue, and when the apparatus for controlling power distribution finds that the available power capacity of the power grid is larger than or equal to the power demand capacity of the first power request in the waiting queue, the power grid can be controlled to supply power to the user equipment corresponding to the first power request in the waiting queue; otherwise, the next power request in the waiting queue can be processed in accordance with the sequence of the queue.

From the above mentioned example, the present disclosure may supply demand power capacities to multiple pieces of user equipment in a flexible way with a fixed total power capacity, wherein the multiple pieces of user equipment can have characteristics standby time and short operating time, and a waiting instruction can be sent to the user equipment when the current available capacity is not enough to support the power demand capacity of the user equipment. In this way, the user equipment may not enter into the operating mode until the available power capacity of the power grid is sufficient to support its demanded power capacity, but the waiting time therebetween is typically not very long. Thus the above controlling power distribution may provide a mechanism to satisfy the power demands of user equipment which may require high instantaneous power and thereby greatly improve the efficiency of power utilization. The present disclosure is a method or apparatus for controlling power distribution which is intended for the fixed capacity power grids to satisfy the power demands, and reduce the cost of a power supply facilities.

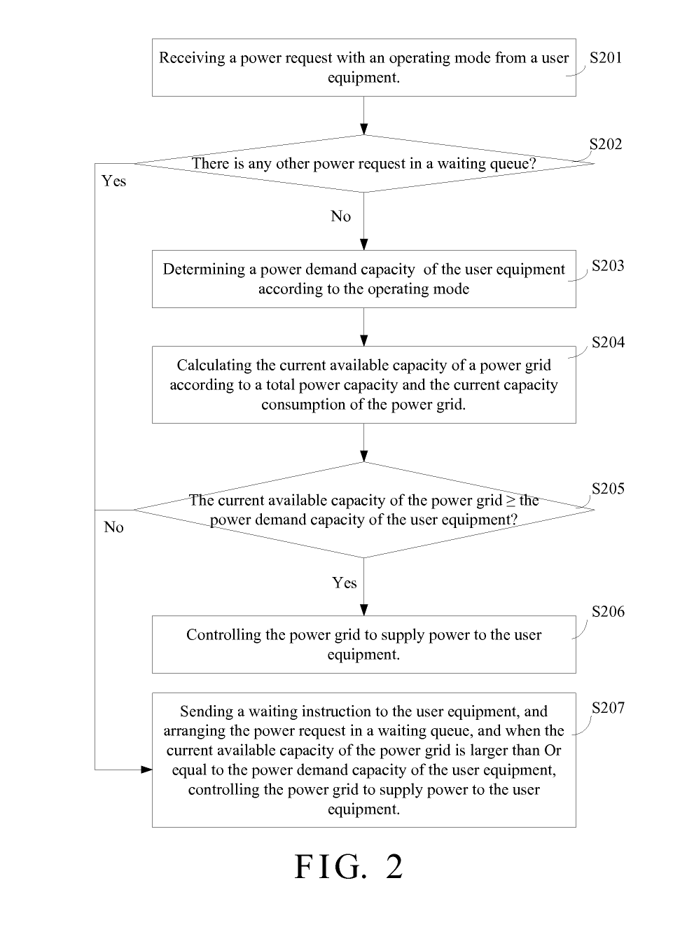

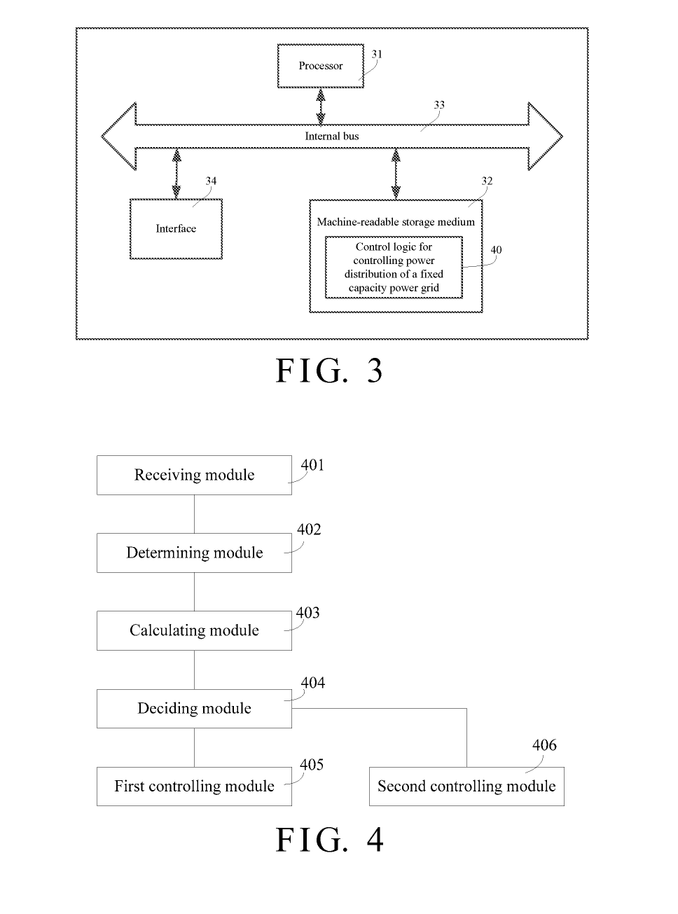

Referring to FIG. 2, FIG. 2 is a flowchart illustrating an example of the controlling power distribution of a fixed capacity power grid. The method can be applied in an apparatus for controlling power distribution, including:

At block S201, a power request with an operating mode can be received from a piece of user equipment.

At block S202, it can be checked whether there is any other power request in a waiting queue; if there is, the method proceeds to block S207, and otherwise, the method proceeds to block S203.

At block S203, a power demand capacity of the user equipment can be determined according to the operating mode.

At block S204, the current available capacity of a power grid can be calculated according to a total power capacity and the current capacity consumption of the power grid.

At block S205, it can be decided whether the current available capacity of the power grid is larger than or equal to the power demand capacity of the user equipment; if it is, going to block S206, and otherwise, going to block S207.

At block S206, the power grid can be controlled to supply power to the user equipment.

At block S207, a waiting instruction can be sent to the user equipment, and the power request from the user equipment can be placed in a waiting queue, and when the current available capacity of the power grid is larger than or equal to the power demand capacity of the user equipment corresponding to the first power quest in the waiting queue, controlling the power grid to supply power to the user equipment corresponding to the first power request in the waiting queue.

Blocks S201 and S203˜S207 in the example of the present disclosure are the same with the corresponding blocks in the above mentioned example, thus the related detail description therewith is not provided for simplicity.

From the above mentioned example, in the present disclosure, after receiving a power request from a piece of user equipment, it can be checked whether there is any other request(s) in a waiting queue. If there is, it indicates that the current available power capacity cannot satisfy the power demand capacity of the user equipment while the power request is directly placed in the waiting queue to avoid a subsequent determining process that may be futile, thus improving the processing efficiency. And if there is not, it can be determined whether the available power capacity of the power grid is able to satisfy the power demand capacity of the user equipment, and if the power grid is not able to, a waiting instruction can be sent to the user equipment, and when the power grid can satisfy the power demand capacity of the user equipment, the user equipment may enter into an operating mode. The waiting time therebetween for the user equipment is typically not long. Thus the power distribution controlling may provide a mechanism to satisfy the power demands of user equipment which may require high instantaneous power and thereby greatly improve the power efficiency. The present disclosure is a method or apparatus for controlling power distribution which is intended for fixed capacity power grids to satisfy the demand power, and reduce cost for power supply facilities.

In some other examples, the method for controlling power distribution of the present disclosure may include:

monitoring whether the current capacity consumption of the power grid has reached a pre-set maximum capacity consumption, and if it is, an instruction can be sent to pause power requesting to all user equipment; and

monitoring the current capacity consumption of the power grid and timely noticing the equipment to avoid sending a power request during a busy period so as to prevent backlogging of requests.

Referring to FIG. 3, FIG. 3 provides an apparatus for controlling power distribution of a fixed capacity power grid in accordance with one example of the disclosure. As shown in FIG. 3, the apparatus may comprise a processor 31 and a storage medium 32, which is connected with the processor 31 through an internal bus 33. In some examples, the apparatus may further comprise an external interface 34 to be able to be in communication with other devices or apparatuses or components.

In different examples, the storage medium 32 may include: random access memory (RAM), volatile memory, non-volatile memory, flash memory, storage drive (such as hard disk drive), solid state disk, other types of disk storage (such as optical disk and DVD, etc) or similar types of storage medium, or combinations thereof.

Further, the storage medium 32 may be configured to store machine-readable instructions corresponding to a control logic 40 for controlling power distribution of a fixed capacity power grid. The control logic may comprise a receiving module 401, a determining module 402, a calculating module 403, a deciding module 404, a first controlling module 405 and a second controlling module 406.

Wherein, the receiving module 401 can be configured to receive a power request with an operating mode from a piece of user equipment. The determining module 402 can be configured to determine the power demand capacity of the user equipment according to the operating mode. The calculating module 403 can be configured to calculate the current available capacity of the power grid according to the total capacity and the current capacity consumption of the power grid. The deciding module 404 can be configured to decide whether the current available capacity of the power grid is larger than or equal to the power demand capacity of the user equipment; if it is, the first controlling module can be controlled, and otherwise, the second controlling module can be trigger. The first controlling module 405 can be configured to control the power grid to supply power to the user equipment. The second controlling module 406 can be configured to send a waiting instruction to the user equipment, and place the power request into a queue, and when the current available capacity of the power grid is larger than or equal to the power demand capacity of the user equipment corresponding to the first power request in the waiting queue, control the power grid to supply power to the user equipment corresponding to the first power request in the waiting queue.

According to an example, the calculating module specifically includes:

a first calculating sub-module, which can be configured to calculate the sum of the power demand capacities of one or more pieces of user equipment that are in an operating state and the standby power demand capacity of all the user equipment, as the current capacity consumption; and

a second calculating sub-module, which can be configured to calculate the difference between the total capacity of the power grid and the current capacity consumption as the current available power capacity of the power grid.

According to an example, the second controlling module can comprise:

a first indicating & sequencing sub-module, which can be configured to send a waiting instruction to the user equipment, and place the power request from the user equipment into the waiting queue according to a descending order for the priority associated with the power requests in the waiting queue and/or an ascending order for the reception time of the power requests in the waiting queue; and

a first controlling & processing sub-module, which can be configured to sequentially process the power requests in the waiting queue, and when the current available capacity of the power grid is larger than or equal to the power demand capacity of the user equipment corresponding to the first power request in the waiting queue, the power grid can be controlled to supply power to the user equipment corresponding to the first power request in the waiting queue.

According to an example, the second controlling module can comprise:

a second indicating & sequencing sub-module, which can be configured to send a waiting instruction to the user equipment, and place the power request from the user equipment into a waiting queue according to an ascending order for the power demand capacity of the power requests in the waiting queue; and

a second controlling & processing sub-module, which can be configured to sequentially process the power requests in the waiting queue, and when the current available capacity of the power grid is larger than or equal to the power demand capacity of the first power request in the waiting queue, the power grid can be controlled to supply power to the user equipment corresponding to the first power request in the waiting queue.

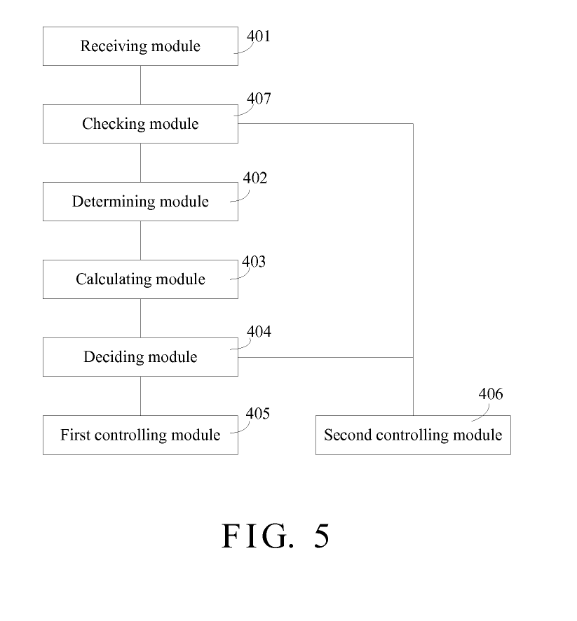

In some other examples, the present disclosure may further includes a checking module 407, which can be configured to check whether there is any other power requests in the waiting queue, and if there is, the second controlling module 406 can be trigger, otherwise, the determining module 402 can be triggered. FIG. 5 provides some details about the determining module 402, illustrating functional blocks in the apparatus for controlling power distribution of a fixed capacity power grid in another example of the present disclosure.

In some other examples, a system in accordance with the present disclosure can include a monitoring module, which can be configured to monitor whether the current capacity consumption of the power grid has reached a preset maximum supply, and if it has, an instruction can be sent to all user equipment to pause power requests.

From the above mentioned example, the present disclosure may supply the power demand capacities to a piece of user equipment in a flexible way with a fixed total capacity wherein the user equipment have characteristics of long standby time and short operating time, and a waiting instruction can be sent to the user equipment when the current available capacity is not enough to support the power demand capacity of the user equipment. In this way, the user equipment may not enter into the operating mode until the available power capacity of the power grid is sufficient to support its demanded power capacity, but the waiting time therebetween is typically not very long. Thus the above controlling power distribution may provide a mechanism to satisfy the power demands of user equipment which may require high instantaneous power and thereby greatly improve the efficiency of power utilization. The present disclosure is a method or apparatus for controlling power distribution which is intended for the fixed capacity power grids to satisfy the power demands, and reduce the cost of a power supply facilities.

The following is an example of software implementation further illustrating a control logic 40 for controlling power distribution of a fixed capacity power grid in an apparatus having the corresponding function. In the above example, the control logic 40 of the present disclosure should be regarded as computer readable instructions stored in a storage medium 32. When the processor 31 executes the control logic 40, the processor 31 invokes instructions of the corresponding functional blocks of the control logic 40 stored on a storage medium 32 and performs the following operations:

receiving a power request with an operating mode from a piece of user equipment;

determining the power demand capacity of the user equipment according to the operating mode;

deciding whether the current available capacity of the power grid is larger than or equal to the power demand capacity of the user equipment;

if it is, controlling the power grid to supply power to the user equipment; and

otherwise, sending a waiting instruction to the user equipment, and arranging the power request into a queue, and when the current available capacity of the power grid is larger than or equal to the power demand capacity of the user equipment corresponding to the first power request in the waiting queue, controlling the power grid to supply power to the user equipment corresponding to the first power request in the waiting queue.

Further, the processor invokes the machine-readable instructions to calculate the current available power capacity of the power grid according to a total power capacity of the power grid and its current capacity consumption, and specifically performs the following operations:

calculating the sum of the power demand capacities of the user equipment in an operating state and the standby power demand capacity of all the user equipment, as the current capacity consumption; and

calculating the difference between the total capacity of the power grid and the current capacity consumption as the current available power capacity of the power grid.

According to an example, the processor invokes machine-readable instructions to send a waiting instruction to said user equipment and arrange the power request into a waiting queue, and when the available power capacity of the power grid is larger than or equal to the power demand capacity of the user equipment corresponding to the first power request in the waiting queue, control the power grid to supply power to the user equipment corresponding to the first power request in the waiting queue, and specifically performs the following operations:

sending a waiting instruction to the user equipment, and arranging the power request into the waiting queue according to a descending order for the priority of the power requests in the waiting queue and an ascending order for the reception time of the power requests in the waiting queue; and

sequentially processing the power requests in the waiting queue, and when the current available capacity of the power grid is larger than or equal to the power demand capacity of the first power quest in the waiting queue, controlling the power grid to supply power to the user equipment corresponding to the first power request in the waiting queue.

According to another example, the processor invokes the machine-readable instructions to send a waiting instruction to the user equipment and arrange the power request into a waiting queue, when the current available power capacity of the power grid is larger than or equal to the power demand capacity of the user equipment corresponding to the first power request in the waiting queue, control the power grid to supply power to the user equipment corresponding to the first power request in the waiting queue, and specifically performs the following operations:

sending a waiting instruction to the user equipment, and arranging the power request into a waiting queue according to an descending order for the power demand capacity of the power requests in the waiting queue; and

sequentially processing the power requests in the waiting queue, and when the current available capacity of the power grid is larger than or equal to the power demand capacity of the first power request in the waiting queue, controlling the power grid to supply power to the user equipment corresponding to the first power request in the waiting queue.

According to another example, the processor invokes the machine-readable instructions to perform the following operations:

after receiving the power request with an operating mode from the user equipment, checking whether there is any other power request in the queue,

if there is, sending a waiting instruction to the user equipment and arranging the power request into the queue; and

if there is not, performing the operation of determining the power demand capacity of the user equipment according to the operating mode.

According to another example, the processor invokes the machine-readable instructions to perform the following operation:

monitoring whether the current capacity consumption of the power grid has reached a preset maximum supply, and

if it has, sending an instruction to all user equipment to pause power requests.

The above are only preferred examples of the present disclosure is not intended to limit the disclosure within the spirit and principles of the present disclosure, any changes made, equivalent replacement, or improvement in the protection of the present disclosure should contain within the range.

The methods, processes and units described herein may be implemented by hardware (including hardware logic circuitry), software or firmware or a combination thereof. The term ‘processor’ can be configured to be interpreted broadly to include a processing unit, ASIC, logic unit, or programmable gate array etc. The processes, methods and functional units may all be performed by the one or more processors; reference in this disclosure or the claims to a ‘processor’ should thus be interpreted to mean ‘one or more processors’.

Further, the processes, methods and functional units described in this disclosure may be implemented in the form of a computer software product. The computer software product is stored in a storage medium and comprises a plurality of instructions for making a processor to implement the methods recited in the examples of the present disclosure.

The figures are only illustrations of an example, wherein the units or procedure shown in the figures are not necessarily essential for implementing the present disclosure. Those skilled in the art will understand that the units in the device in the example can be arranged in the device in the examples as described, or can be alternatively located in one or more devices different from that in the examples. The units in the examples described can be combined into one module or further divided into a plurality of sub-units.

Although the flowcharts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

Throughout the present disclosure, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for controlling power distribution of a fixed capacity power grid, the method comprising:
receiving a power request from a piece of user equipment, the power request indicating an operating mode of the user equipment;
determining a power demand capacity of the user equipment according to the operating mode;
determining whether a current available capacity of the power grid is larger than or equal to the power demand capacity of the user equipment;
if the current available capacity of the power grid is larger than or equal to the power demand capacity of the user equipment, controlling the power grid to supply power to the user equipment; and
if the current available capacity of the power grid is less than the power demand capacity of the user equipment:
sending a waiting instruction to the user equipment,
placing the power request into a waiting queue, and
when the current available capacity of the power grid is larger than or equal to the power demand capacity of the user equipment corresponding to the first power request in the waiting queue, controlling the power grid to supply power to the user equipment corresponding to the first power request in the waiting queue.

2. The method according to claim 1, further comprising:
calculating the sum of the power demand capacities of one or more pieces of user equipment on the power grid that are in an operating state and the standby power demand capacity of all user equipment on the power grid as the current capacity consumption; and
calculating the difference between the total capacity of the power grid and the current capacity consumption as the current available power capacity of the power grid.

3. The method according to claim 1, further comprising:
sorting all power requests in the waiting queue according to a descending order for the priority of the power requests in the waiting queue and an ascending order for the reception time of the power requests in the waiting queue.

4. The method according to claim 1, further comprising:
sorting all power requests in the waiting queue according to an ascending order for the power demand capacity of the power requests in the waiting queue.

5. The method according to claim 1, further comprising:
after receiving the power request from the user equipment, checking whether there is any other power request in the waiting queue,
if there is, sending a waiting instruction to the user equipment and placing the power request into the waiting queue; and
if there is not, determining the power demand capacity of the user equipment according to the operating mode.

6. The method according to claim 1, further comprising:
monitoring whether the current capacity consumption of the power grid has reached a preset maximum supply, and if it has, sending an instruction to all user equipment on the power grid to pause power requests.

7. The method according to claim 1, wherein
the placement of the power request from the user equipment is based on a power demand capacity of the user equipment,
the waiting instruction is sent to the user equipment when the current available capacity of the power grid is less than the power demand capacity of the user equipment, and
the power request from the user equipment is processed when the current available capacity of the power grid is larger than or equal to the power demand capacity of the power request such that the power grid is controlled to supply power to the user equipment.

8. The method according to claim 1, further comprises:
after receiving the power request from the user equipment, checking whether there is any other power request in the waiting queue; and, wherein
the determination of the power demand capacity of the user equipment is performed when there is no other power request in the waiting queue, and
the sending of the waiting instruction to the user equipment and the placement of the power request from the user equipment into the waiting queue are performed when there is at least on other power request in the waiting queue.

9. An apparatus for controlling power distribution of a fixed capacity power grid, the apparatus comprising:
a processor configured to execute machine-readable instructions corresponding to a control logic for controlling the power distribution, and the machine readable instructions, when executed, cause the process to:
receive a power request from a piece of user equipment, the power request indicating an operating mode of the user equipment;
determine a power demand capacity of the user equipment according to the operating mode;
determine whether a current available capacity of the power grid is larger than or equal to the power demand capacity of the user equipment;
if the current available capacity of the power grid is larger than or equal to the power demand capacity of the user equipment, control the power grid to supply power to the user equipment; and
if the current available capacity of the power grid is less than the power demand capacity of the user equipment:
send a waiting instruction to the user equipment,
place the power request into a waiting queue, and
when the current available capacity of the power grid is larger than or equal to the power demand capacity of the user equipment corresponding to the first power request in the waiting queue, control the power grid to supply power to the user equipment corresponding to the first power request in the waiting queue.

10. The apparatus according to claim 9, wherein the machine-readable instructions further cause the processor to:
calculate the sum of the power demand capacities of one or more pieces of user equipment on the power grid that are in an operating state and the standby power demand capacity of all user equipment on the power grid as the current capacity consumption; and
calculate the difference between the total capacity of the power grid and the current capacity consumption as the current available power capacity of the power grid.

11. The apparatus according to claim 9, wherein the machine-readable instructions further cause the processor to:
sort all power requests in the waiting queue according to a descending order for the priority of the power requests in the waiting queue and an ascending order for the reception time of the power requests in the waiting queue.

12. The apparatus according to claim 9, wherein the machine-readable instructions further cause the processor to:
sort all power requests in the waiting queue according to an ascending order for the power demand capacity of the power requests in the waiting queue.

13. The apparatus according to claim 9, wherein the machine-readable instructions further cause the processor to:
after receiving the power request from the user equipment, check whether there is any other power request in the waiting queue,
if there is, send a waiting instruction to the user equipment and place the power request into the waiting queue; and
if there is not, determine the power demand capacity of the user equipment according to the operating mode.

14. The apparatus according to claim 9, wherein the machine-readable instructions further cause the processor to:
monitor whether the current capacity consumption of the power grid has reached a preset maximum supply, and
if it has, send an instruction to all user equipment on the power grid to pause power requests.

15. The apparatus according to claim 9, wherein
the placement of the power request from the user equipment is based on a power demand capacity of the user equipment,
the waiting instruction is sent to the user equipment when the current available capacity of the power grid is less than the power demand capacity of the user equipment, and
the power request from the user equipment is processed when the current available capacity of the power grid is larger than or equal to the power demand capacity of the power request such that the power grid is controlled to supply power to the user equipment.

16. The method according to claim 9, further comprises:
after receiving the power request from the user equipment, checking whether there is any other power request in the waiting queue; and, wherein
the determination of the power demand capacity of the user equipment is performed when there is no other power request in the waiting queue, and
the sending of the waiting instruction to the user equipment and the placement of the power request from the user equipment into the waiting queue are performed when there is at least on other power request in the waiting queue.
